(19) United States
(12) Patent Application Publication
(10) Pub. No.: US 2005/0163401 A1
(43) Pub. Date: Jul. 28, 2005

(54) Display image enhancement apparatus and method using adaptive interpolation with correlation

(75) Inventors: Seong H. Park, Pleasanton, CA (US); Jeremy Mah, San Jose, CA (US); Hiroshi Kanekura, San Jose, CA (US)

Correspondence Address: Morgan, Lewis & Bockius LLP, 1111 Pennsylvania Avenue, N.W., Washington, DC, 20004, US

(73) Assignee: Techwell Inc.

(21) Appl. No.: 10/765,130

(22) Filed: Jan. 28, 2004

(51) Int. Cl. G06K 9/40; H04N 7/01

(52) U.S. Cl. 382/300; 348/448

(57) ABSTRACT

A display image enhancement apparatus and method are disclosed for use in generating additional pixel data from input image data, where a window of input pixel data is used to generate data for an additional pixel to be placed substantially in the center of the window. The display image enhancement apparatus includes memory elements that is capable of receiving a chain of input pixel data and storing at least the window of input pixel data, where the window of input pixels includes a plurality of pixel pairs each of which respectively represents an angle of correlation. The display image enhancement apparatus also includes instant angle detection circuitry capable of receiving the input pixel data stored in the memory elements and determining an instant angle having the highest correlation based on differential values of at least some of the pixel pairs, where a differential value is the difference between the values of pixels in a pixel pair. The display image enhancement apparatus further includes substantial angle detection circuitry capable of determining a substantial angle having the highest correlation based on filtered differential values of at least some of the pixel pairs. Angle confirmation circuitry is provided to determine an interpolation angle based on the instant angle and the substantial angle. The display image enhancement apparatus employs an interpolator that is capable of determining the value of the additional pixel based on the values of pixels in the pixel pair corresponding to the interpolation angle.

### BACKGROUND OF THE INVENTION

1. Field of the Invention

The present invention relates to a display image enhancement apparatus and method and, more particularly, to an apparatus and method for enhancing the quality of image on a display, such as a television, monitor, or other types of displays.

2. Discussion of the Related Art

Typically, broadcast video signals (NTSC/PAL) are interlaced to reduce the bandwidth needed for broadcasting purposes. This allows for relatively high refresh rates, thereby reducing large area flickering. Interlacing video signals, however, reduce the vertical resolution of the displayed image.

As shown in FIG. 1A, in an interlaced scan, a video signal is generated by alternatively scanning the odd lines and even lines of an image. In one refresh cycle, the odd lines of the image, shown as solid lines, are scanned. In the next refresh cycle, the even lines of the image, shown as dotted lines, are scanned. Then, the odd lines are again scanned, followed by the even lines, and so on. In contrast, as shown in FIG. 1B, in a progressive scan, a video signal is generated by scanning all of the lines of the image, including both odd and even lines, in each refresh cycle.

CRT monitors typically support video signals in both the interlaced format and progressive format. However, some of the more recently developed display devices, such as some TFT-LCDs, do not support interlaced video signals. Thus, in order to display interlaced video signals, such as the traditional broadcast signals (NTSC/PAL), on these new display devices, the interlaced signals must be converted into the progressive format. The device for converting interlaced signals into the progressive format is referred to as a “de-interlace engine,” “line doubler,” or “resolution enhancer.”

Since interlaced signals include, for a given refresh cycle, only a half of the lines of a full image, the other half of the lines must be generated in order to convert interlaced signals into progressive signals. For example, if the interlaced signals include the odd lines of the image, the even lines must be generated to convert the signals into the progressive format. One simple method of such a conversion is referred to as the “Bob-deinterlacer.” The Bob-deinterlacer generates the extra lines (e.g., even lines) of pixels by simply taking the average value of the available signals for pixels (e.g., odd lines) directly above and directly below. Although this conversion method is simple and easy to implement, it often results in blurry images and causes zig-zagging, especially at lines or edges in the image at low angles (i.e., lines or edges that are close to being horizontal or vertical).

There are various deinterlacing techniques. These techniques include linear filtering methods, such as spatial filtering, temporal filtering, and VT filtering. The Bob-deinterlacer is an example of a linear deinterlacer. Also, non-linear or adaptive techniques can be utilized to generate additional lines of pixels, including for example, motion adaptive, edge-dependent interpolation, and correlation techniques. These various linear and non-linear deinterlacing techniques are described in “De-interlacing—an overview,” G. de Haan, et al., Proceedings of the IEEE Vol. 86, No. 9, September 1998, which is incorporated herein by reference. To a varying extent, these various deinterlacing techniques similarly suffer from the drawback of blurry images and/or zig-zagging. In addition, some of these techniques are also difficult to implement.

Correlation is a technique for generating additional pixels by using the relationship among the neighboring pixels. For example, in the image shown in FIG. 2, an edge is located through pixel F to pixel K. With the Bob-deinterlacer, the value of pixel X to be generated would be the average value of the pixel pair DM. However, the differences between the values of respective pixel pairs AP, BO, CN, DM, EL, and GJ are are each greater than the difference between the values of the pixel pair FK. The pixel pair FK has a higher correlation than any of the other pixel pairs, including the DM pair. Thus, in generating the value of pixel X, the average value of the pixel pair FK is a better representation of the value of pixel X than the average of other pixel pairs, including the DM pair.

In order to process a line or an edge in the image having a low angle (i.e., near horizontal or near vertical line or edge) effectively, the window of neighboring pixels used for the correlation technique needs to be expanded. However, with an expanded window, a differential value of a pixel pair far apart from each other is not easily distinguishable from a difference caused by noise in the transmitted video image signal. Also, with an expanded window, the deinterlacing process becomes less efficient as more input values must be used to calculate additional pixels.

Moreover, the correlation technique is not effective in displaying thin line objects because thin line objects cannot easily be distinguished from the background. For example, if the dotted line through pixels F and K in FIG. 2 represents a thin black line on a white background, the differential value of the pixel pair FK is approximately zero. The differential values of the other pixel pairs are also zero or approximately zero. Hence, the correlation technique is not effective in distinguishing thin line objects from the background.

### SUMMARY OF THE INVENTION

Accordingly, the present invention is directed to a display image enhancement apparatus and method that substantially obviates one or more of the problems due to limitations and disadvantages of the related art.

An object of the present invention is to provide a system that is capable of converting an interlaced signal into a progressively scanned signal with improved quality of the displayed image, especially at low angle (i.e., near horizontal or near vertical) edges or at thin lines in the image.

Another object of the present invention is to provide a system that uses substantial angle observation (time based) and regional observation (area based) techniques to convert an interlaced signal into a progressive format with improved image quality, especially at low angle edges and thin lines in the image.

Yet another object of the present invention is to provide an improved deinterlacing system that uses a relatively large window of pixels efficiently to generate additional pixels while minimizing the effects of any noise in the input video signals.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the display image enhancement apparatus for use in generating additional pixel data from input image data, wherein a window of input pixel data is used to generate data for an additional pixel to be placed substantially in the center of the window, includes memory elements capable of receiving a chain of input pixel data and storing at least the window of input pixel data, the window of input pixels including a plurality of pixel pairs each of which respectively represents an angle of correlation; instant angle detection circuitry capable of receiving the input pixel data stored in the memory elements and determining an instant angle having the highest correlation based on differential values of at least some of the pixel pairs, wherein a differential value is the difference between the values of pixels in a pixel pair; substantial angle detection circuitry capable of determining a substantial angle having the highest correlation based on filtered differential values of at least some of the pixel pairs; angle confirmation circuitry capable of determining an interpolation angle based on the instant angle and the substantial angle; and an interpolator capable of determining the value of the additional pixel based on the values of pixels in the pixel pair corresponding to the interpolation angle.

In another aspect of the invention, the display image enhancement apparatus for use in generating additional pixel data from input image data, wherein a window of input pixel data includes a plurality of regions and is used to generate data for an additional pixel to be placed substantially in the center of the window, includes memory elements capable of receiving a chain of input pixel data and storing at least the window of input pixel data, the window of input pixels including a plurality of pixel pairs each of which respectively represents an angle of correlation; instant angle detection circuitry capable of receiving the pixel data stored in the memory elements and determining an instant angle having the highest correlation based on differential values of at least some of the pixel pairs, wherein a differential value is the difference between the values of pixels in a pixel pair and wherein the instant angle detection circuitry includes a differential calculator capable of calculating differential values of at least some of the pixel pairs in the window, a global region detector capable of selecting a representative pixel pair from each of the regions, determining the representative pixel pair having the lowest differential value among the representative pixel pairs, and selecting the region represented by the representative pixel pair with the lowest differential value, a first valley detector capable of comparing the differential values of consecutive sets of immediately adjacent pixel pairs within the selected region and determining a pixel pair having a differential value that is smaller than the differential values of available immediately adjacent pixel pairs to the left and to the right in the selected region, and angle finding circuitry capable of determining an angle corresponding to the pixel pair determined by the first valley detector as the instant angle; and an interpolator capable of determining the value of the additional pixel based on the values of pixels in the pixel pair corresponding to the instant angle.

In yet another aspect of the invention, the display image enhancement apparatus for use in generating additional pixel data from input image data, wherein a window of input pixel data is used to generate data for an additional pixel to be placed substantially in the center of the window, includes memory elements capable of receiving a chain of input pixel data and storing at least the window of input pixel data, the window of input pixels including a plurality of pixel pairs each of which respectively represents an angle of correlation; a differential calculator capable of calculating a differential value of at least some of the pixel pairs in the window based on the input pixel data, wherein a differential value is the difference between the values of pixels in a pixel pair; substantial angle detection circuitry capable of determining a substantial angle having the highest correlation based on filtered differential values of at least some of the pixel pairs, wherein the substantial angle detection circuitry includes a recursive filter capable of filtering the differential values of at least some of the pixel pairs in the window and outputting the filtered differential values; and an interpolator capable of determining the value of the additional pixel based on the values of pixels in the pixel pair corresponding to the substantial angle.

In another aspect of the invention, the display image enhancement method for use in generating additional pixel data from input image data, wherein a window of input pixel data is used to generate data for an additional pixel to be placed substantially in the center of the window, includes receiving a chain of input pixel data and storing at least the window of input pixel data in memory elements, the window of input pixels including a plurality of pixel pairs each of which respectively represents an angle of correlation; determining differential values of at least some of the pixel pairs based on the input pixel data stored in the memory elements, wherein a differential value is the difference between the values of pixels in a pixel pair; determining an instant angle having the highest correlation based on the differential values of at least some of the pixel pairs; determining a substantial angle having the highest correlation based on filtered differential values of at least some of the pixel pairs; determining an interpolation angle based on the instant angle and the substantial angle; and determining the value of the additional pixel based on the values of pixels in the pixel pair corresponding to the interpolation angle.

In yet another aspect of the invention, the display image enhancement method for use in generating additional pixel data from input image data, wherein a window of the pixel data includes a plurality of regions and is used to generate data for an additional pixel to be placed substantially in the center of the window, includes receiving a chain of input pixel data and storing at least the window of input pixel data in memory elements, the window of input pixels including a plurality of pixel pairs each of which respectively represents an angle of correlation; determining differential values of at least some of the pixel pairs in the window, wherein a differential value is the difference between the values of pixels in a pixel pair; determining an instant angle having the highest correlation based on differential values of at least some of the pixel pairs, wherein the determining of the instant angle includes selecting a representative pixel pair from each of the regions, determining the representative pixel pair having the lowest differential value among the representative pixel pairs, selecting the region represented by the representative pixel pair with the lowest differential value, comparing the differential values of consecutive sets of immediately adjacent pixel pairs within the selected region and determining a first valley pixel pair, wherein the first valley pixel pair has a differential value that is smaller than the differential values of available immediately adjacent pixel pairs to the left and to the right in the selected region, and determining an angle corresponding to the first valley pixel pair as the instant angle; and determining the value of the additional pixel based on the values of pixels in the pixel pair corresponding to the instant angle.

In another aspect of the invention, the display image enhancement method for use in generating additional pixel data from input image data, wherein a window of the pixel data is used to generate data for an additional pixel to be placed substantially in the center of the window, includes receiving a chain of input pixel data and storing at least the window of input pixel data in memory elements, the window of input pixels including a plurality of pixel pairs each of which respectively represents an angle of correlation; calculating a differential value of at least some of the pixel pairs in the window based on the input pixel data stored in the memory elements, wherein a differential value is the difference between the values of pixels in a pixel pair; determining a substantial angle having the highest correlation based on filtered differential values of at least some of the pixel pairs, wherein the step of determining the substantial angle includes filtering the differential values of at least some of the pixel pairs in the window using a recursive filter; and determining the value of the additional pixel based on the values of pixels in the pixel pair corresponding to the substantial angle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A illustrates an interlaced scanning method;

FIG. 1B illustrates a progressive scanning method;

FIG. 2 illustrates an exemplary embodiment of a pixel window used to generate an additional pixel according to the present invention;

FIG. 3 illustrates a block diagram of an exemplary embodiment of the display image enhancement apparatus according to the present invention;

FIG. 4 illustrates an exemplary embodiment of a pixel window used to generate an additional pixel according to the present invention;

FIGS. 5A and 5B illustrate examples of how the instant angle may be determined according to the present invention;

FIGS. 6A and 6B illustrate examples of instances where the detected instant angle may not be reliable according to the present invention;

FIGS. 7A and 7B illustrate examples of instances where the detected substantial angle is likely more reliable than the detected instant angle according to the present invention;

FIGS. 8A and 8B illustrate examples of general patterns that can be detected by the regional measurements according to the present invention;

FIGS. 9 and 10 illustrate exemplary embodiments of the instant angle detection circuitry according the present invention; and

FIGS. 11 and 12 illustrate exemplary embodiments of the substantial angle detection circuitry according to the present invention.

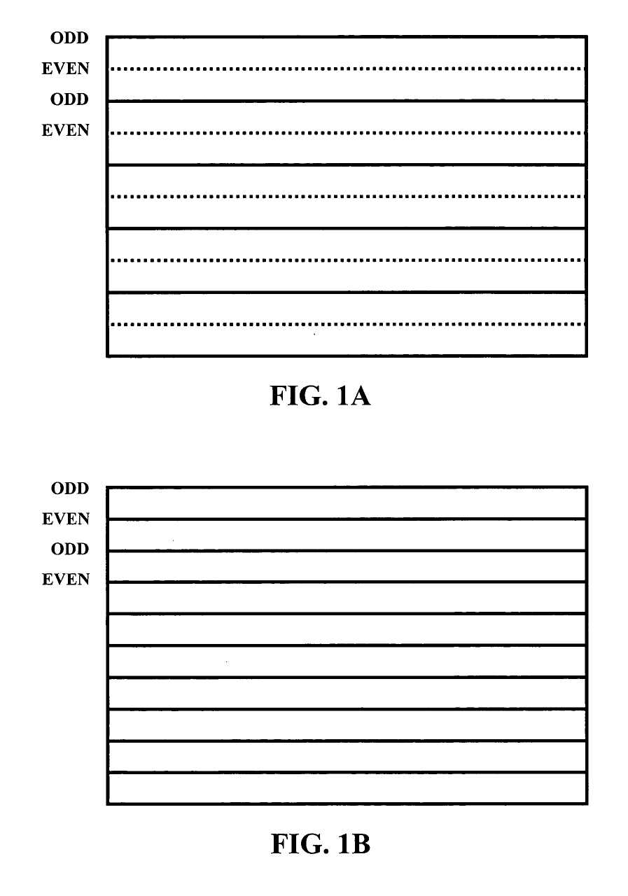

### DETAILED DESCRIPTION OF THE PREFERRED EMBODIMENTS

Reference will now be made in detail to the preferred embodiments of the present invention, examples of which are illustrated in the accompanying drawings.

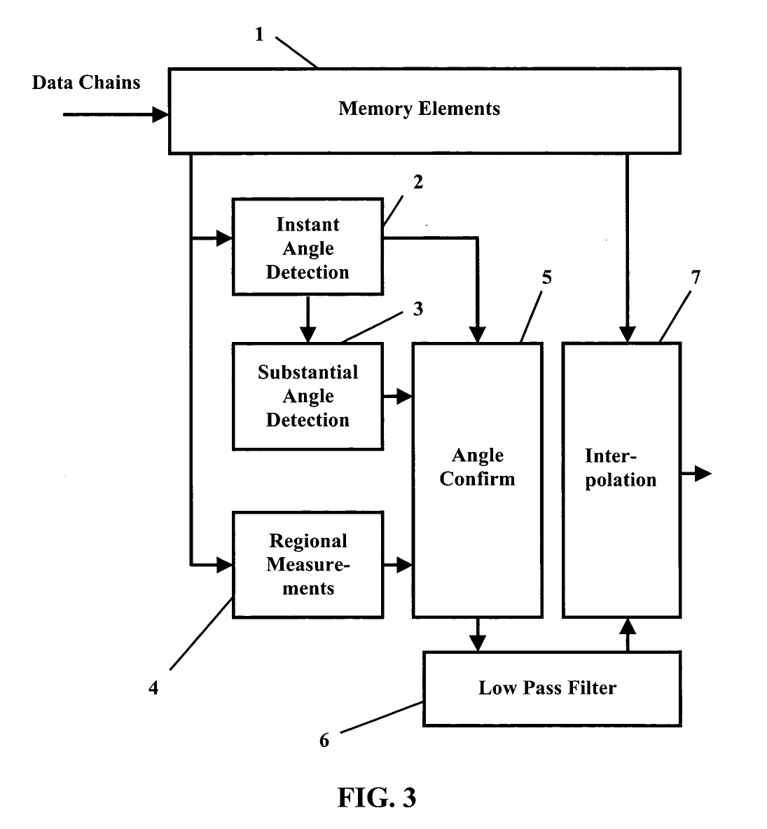

As shown in FIG. 3, the display image enhancement device according to an exemplary embodiment of the present invention includes memory elements 1 that continuously receive and store data chains, i.e., windows of input image pixel data. For example, the memory elements 1 may include a line buffer or another type of data storage element. In the exemplary embodiment shown in FIG. 4, values for each pixel in a window of 15 pixels by 2 pixels (pixels B7-A7 and P7-N7) are stored in memory elements 1, at a given time, for measurement and interpolation to determine the value for an additional pixel (pixel X) to be placed in the center of the window. Windows having sizes other than 15 by 2 may also be used. Also, depending on the requirements of the timing logic and any filtering logic, input image data can be pipe-lined and/or more memory space may be provided to compensate for any delay and to accommodate any filtering of data.

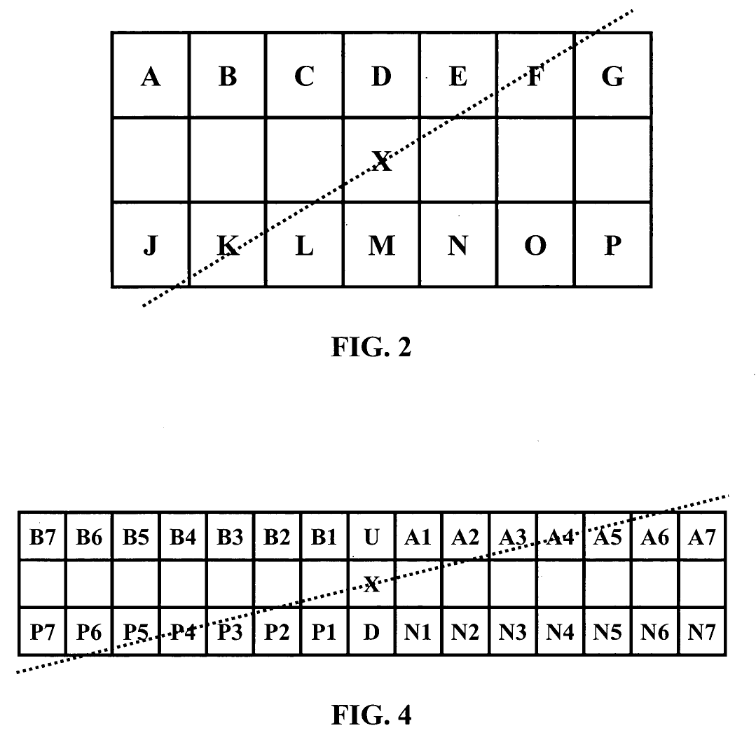

As shown in FIG. 3, the display image enhancement device also includes instant angle detection circuitry 2. The instant angle detection circuitry 2 receives the pixel data stored in memory elements 1 and determines the pixel pair with the lowest differential value. A pixel pair herein refers to a pair of pixels that are on the opposite side of the additional pixel to be created (i.e., pixel X) and are equally distanced from the additional pixel on a straight line. For example, the window of pixels shown in FIG. 2 has seven pixel pairs, AP, BO, CN, DM, EL, FK, and GJ, with respect to pixel X. Each pixel pair represents an angle with respect to the horizontal line. For example, in FIG. 2, the pixel pair DM represents 90°, and the pixel pair CN represents 45° in the clockwise direction with respect to the horizontal line. A differential value simply refers to the difference in values of the two pixels in a pixel pair. The instant angle detection circuitry 2 outputs the angle corresponding to the pixel pair with the lowest differential value as the instant angle having the highest correlation. For example, in the 7-by-2 window of pixels shown in FIG. 2, if the pixel pair DM has the smallest difference, the instant angle detection circuitry 2 determines that there is a 90° correlation. If the pixel pair EL has the smallest difference, the instant angle detection circuitry 2 determines that there is a 45° correlation in the counterclockwise direction with respect to the horizontal line. If the pixel pair CN has the smallest difference, a 45° correlation in the clockwise direction is determined.

The instant angle detection circuitry 2 may alternatively employ the first valley detection technique in detecting the instant angle with the highest correlation. For example, starting with the pixel pair at the 90° correlation (i.e., DM), the instant angle detection circuitry 2 compares differential values of pixel pairs. For example, in the 7-by-2 window of pixels shown in FIG. 2, if the pixel pair EL has a smaller differential value than do the pairs FK and DM, the first valley is detected at pixel pair EL, which corresponds to a 45° correlation in the counterclockwise direction with respect to the horizontal line. Then, the instant angle detection circuitry 2 outputs 45° in the counterclockwise direction as the instant angle with the highest correlation.

Even in the event that the pixel pair GJ has a smaller differential value than the pixel pair EL, the instant angle detection circuitry 2 employing the first valley detection technique would output the angle corresponding to the first detected valley in differential value (i.e., 45° in the counterclockwise direction) as the instant angle with the highest correlation. The instant angle detection circuitry 2 may be configured to begin searching for the first valley at any of the pixel pairs, including from the smallest angle in the counterclockwise direction (e.g., GJ) to the smallest angle in the clockwise direction (e.g., AP), from the smallest angle in the clockwise direction to the smallest angle in the counterclockwise direction, and from 90° (e.g., DM).

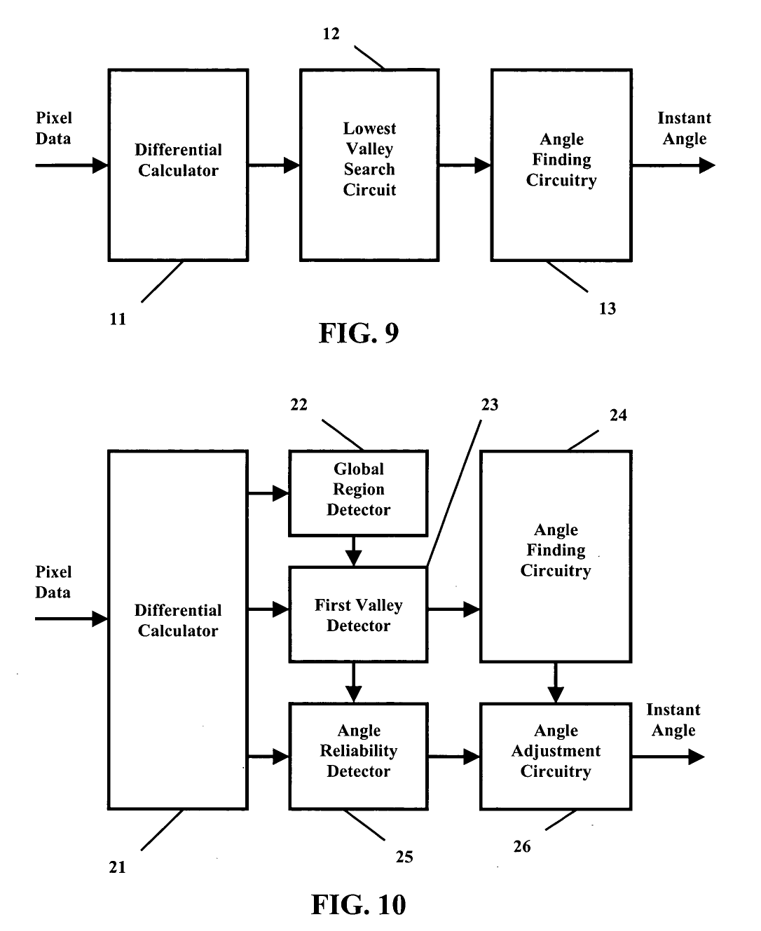

Exemplary embodiments of the instant angle detection circuitry 2 are illustrated in FIGS. 9 and 10, and are discussed below in more detail.

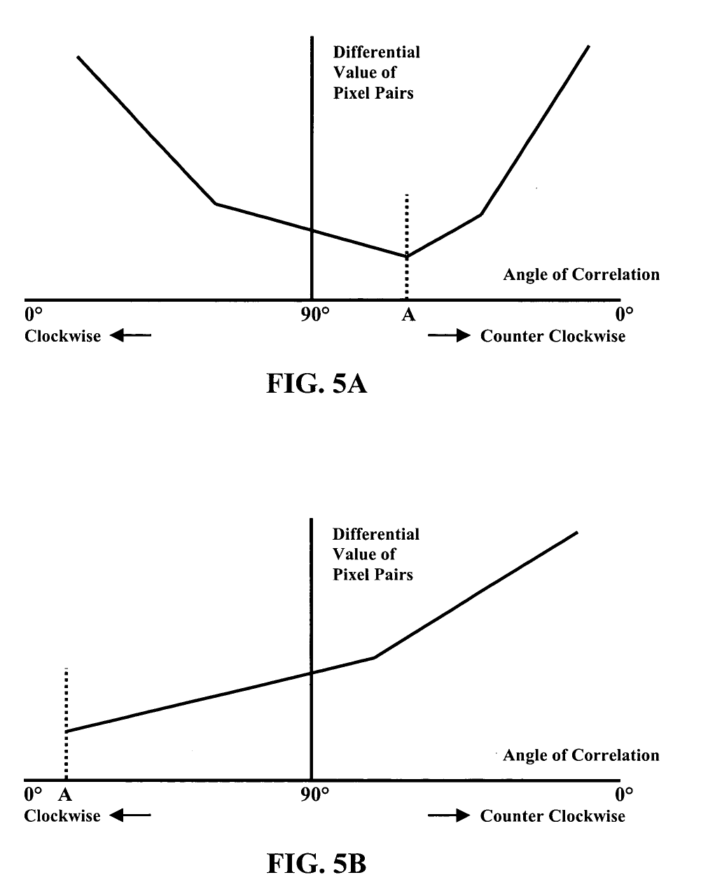

FIGS. 5A and 5B illustrate the determination of the angle A with the highest correlation. As the differential value of one pixel pair is more significantly smaller than the differential values of the other pixel pairs, more reliable is the determination of the angle with the highest correlation by the instant angle detection circuitry 2.

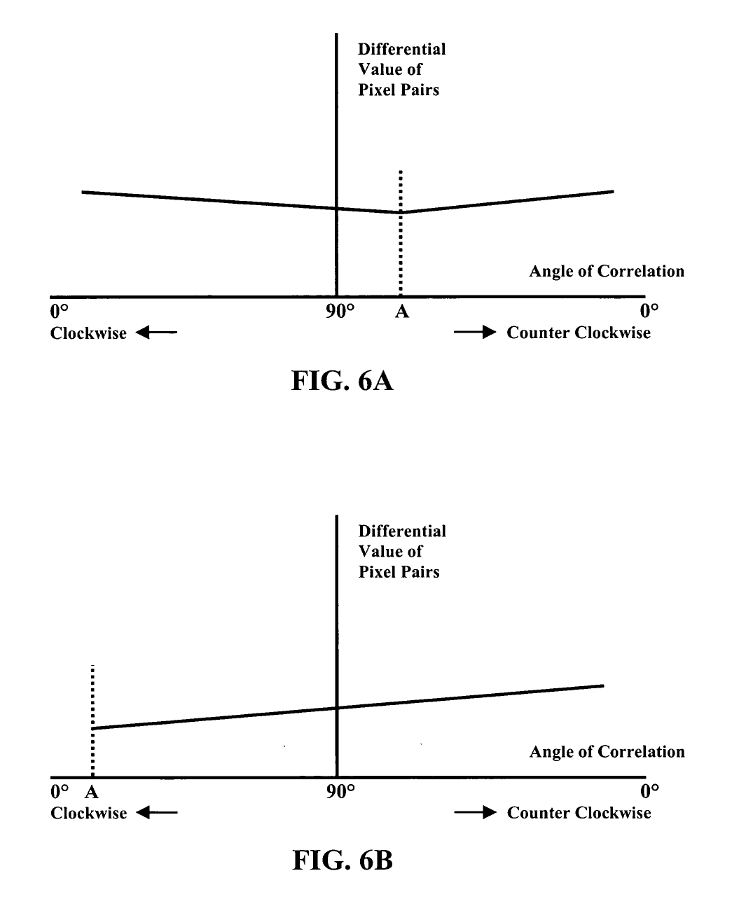

However, when the differential values of pixel pairs do not vary greatly from one pixel pair to another, as shown for example in FIGS. 6A and 6B, the detection of the angle A as having the highest correlation by the instant angle detection circuitry 2 is less reliable. For example, if the dotted line through the pixel pair FK in FIG. 2 represents a thin black line in a white background, the differential values of pixel pairs DM, EL, FK, and GJ are approximately equal to one another. In this case, instant angle detection is less reliable. To compensate for this relative unreliability, the exemplary embodiment of the present invention includes substantial angle detection circuitry 3 as shown in FIG. 3.

The substantial detection circuitry 3 determines the angle of the highest correlation based on filtered differential values. In the exemplary embodiment, the substantial detection circuitry 3 calculates a filtered differential value for a given angle based on differential values for that angle detected in the previously stored window or windows of pixel data (i.e., in a previous cycle or cycles) as well as the differential values for that angle detected in the currently stored window of pixel data. It may also utilize the differential values for the given angle detected in subsequently stored window or windows of pixel data (i.e., in a subsequent cycle or cycles). For example, in FIG. 2, pixel pairs AJ, BK, CL, DM, EN, FO, and GP each correspond to a 90° correlation. Also, though not shown in FIG. 2, there are additional pixel pairs immediately to the right and to the left of the window that correspond to the 90° correlation. A combination of the differential values of one or more of these pixel pairs represents a substantial angle of 90°. This combination may be, for example, a simple sum, weighted sum, average, or weighted average. The number of differential values or pixel pairs used to calculate the combination may be as few as two (2) and may be much larger depending on the application. The numbers between about 8 and about 32 provide reliable results. Thus, depending on the implementation of the substantial detection circuitry 3, more memory space may be needed to store not only the pixel values within the window (see, e.g., FIGS. 2 and 4) but also other values, such as the values of neighboring pixels or the average or combination values representing accumulated pixel data, needed for the calculation of the filtered differential values.

Similarly, pixel pairs B(J−1), CJ, DK, EL, FM, GN, (G+1)O and similarly oriented pixel pairs to the left and to the right of the window in FIG. 2 each correspond to a 45° correlation in the counterclockwise direction. Pixel (J−1) refers to the pixel immediately left of pixel J, and pixel (G+1) refers to the pixel immediately to the right of pixel G. The combination of the differential values of one of more of these pixel pairs represents a substantial angle of 45° in the counterclockwise direction. Also, pixel pairs C(J−2), D(J−1), EJ, FK, GL, (G+1)M, (G+2)N, and similarly oriented pixel pairs to the left and to the right of the window in FIG. 2 each correspond to 27° correlation in the counterclockwise direction. The combination of the differential values of one or more of these pixel pairs represents a substantial angle of 27° in the counterclockwise direction. Then, the combination having the smallest value is selected, and the angle corresponding to that combination is determined as the substantial angle with the highest correlation. In this example, the combination of the differential values for pixel pairs corresponding to 27° in the counterclockwise direction is the smallest. Thus, the substantial angle detection circuitry 3 determines the angle of 27° in the counterclockwise direction as the substantial angle with the highest correlation.

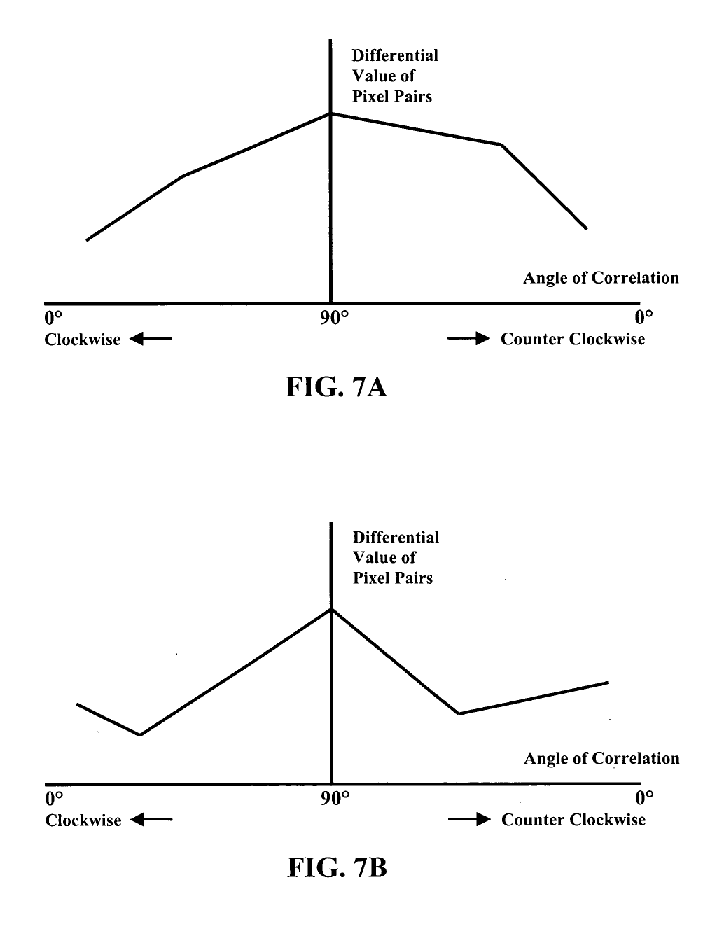

FIGS. 7A and 7B illustrate examples of instant angle detection results where the substantial angle detection likely provides a more reliable determination of the angle with the highest correlation than the instant angle detection.

The substantial angle detection circuitry 3 can be implemented in several different ways. In one exemplary embodiment, the substantial detection circuitry 3 incorporates a recursive filter to filter the differential values of the pixel pairs calculated by the instant angle detection circuitry 2. Then, the filtered differential values of pixel pairs are processed as in the instant angle detection circuitry 2 to determine the angle with the highest correlation. Another way to implement the substantial angle detection technique is to store the previously determined angles of the highest correlation and use a weighted average value of the previously determined angles along with the currently determined angle to determine the substantial angle.

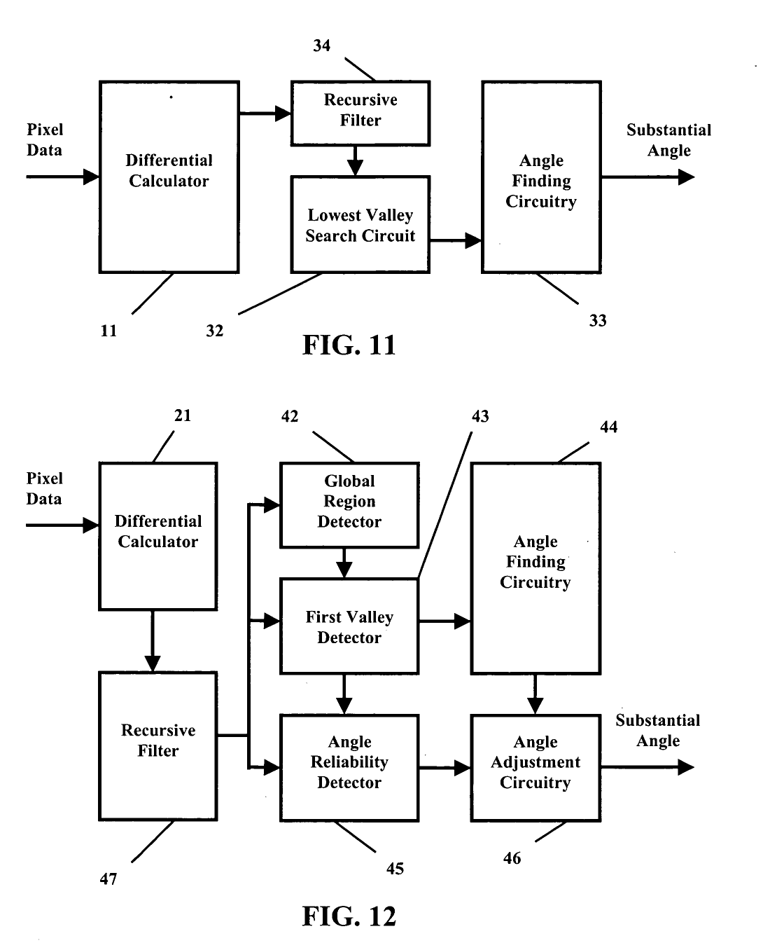

Exemplary embodiments of the substantial angle detection circuitry 3 are illustrated in FIGS. 11 and 12, and are discussed below.

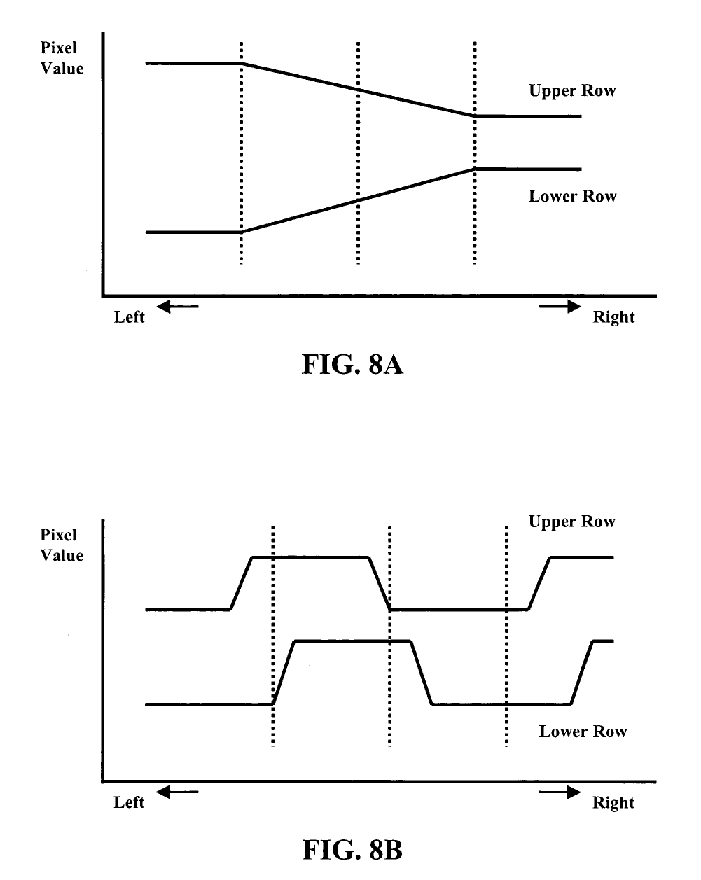

As shown in FIG. 3, the display image enhancement device according to a preferred embodiment may also include regional measurement circuitry 4. The regional measurement circuitry 4 receives pixel data stored in the memory elements 1 and detects a general pattern within the window of pixels whose data are stored in memory elements 1. Examples of detected patterns are illustrated in FIGS. 8A and 8B. Then, the regional measurement circuitry 4 evaluates the relative reliability of instant and substantial angle detections.

For example, in the window as shown in FIG. 2 or FIG. 4, if the upper row of pixels have continuously decreasing values from left to right and the lower row of pixels have continuously increasing values, the differential values of the pixel pairs likely do not vary significantly from pixel pair to pixel pair. This is illustrated in FIG. 8A. If this type of pattern is detected, the substantial angle detection likely provides more reliable results than the instant angle detection. Also, if the neighboring pixels have values that are significantly different from one to next, as shown in FIG. 8B, man-made patterns, such as alphabet characters or numbers, are likely to be displayed. When such man-made patterns are detected, a 90° correlation is selected.

As shown in FIG. 3, the results of the instant angle detection, substantial angle detection, and regional measurement (if implemented) are input to the angle confirmation circuitry 5. The angle confirmation circuitry 5 then determines the interpolation angle. The angle confirmation circuitry 5 compares the detected instant angle and substantial angle. If the two detected angles are substantially the same, then the angle confirmation circuitry 5 selects the detected instant angle, substantial angle, or the average of the two detected angles as the interpolation angle.

If the detected instant angle is found to be unreliable, then the angle confirmation circuitry 5 selects as the interpolation angle either the substantial angle or an weighted average of the two detected angles with the substantial angle given more weight. As discussed above, the examples where the instant angle detection is unreliable include when the detected instant angle is significantly different from the detected substantial angle, when the differential value of each pixel pair within the window remains relatively constant from pixel pair to pixel pair (see, e.g., FIGS. 6A and 6B), and when the upper row of pixels in the window have decreasing values while the low row of pixels have increasing values (see, e.g., FIG. 8A).

In the event the regional measurement circuitry 4 detects a man-made pattern (see, e.g., FIG. 8B), the angle confirmation circuitry 5 sets the interpolation angle at 90°.

The angle confirmation circuitry 5 outputs the calculated interpolation angle to the interpolation circuitry 7. Alternatively, the calculated interpolation angle may be input to a low pass filter (LPF) 6 as shown in FIG. 3 to reduce or eliminate effects of any noise element in the image. Then, the filtered interpolation angle is input to the interpolation circuitry 7. The interpolation circuitry 7 also receives pixel data stored in the memory elements 1 and interpolates the values of the pixel pair corresponding to the interpolation angle to generate the value of the additional pixel (i.e., pixel X).

The instant angle detection circuitry 2 (FIG. 3) can be implemented in different ways. In an exemplary embodiment shown in FIG. 9, the instant angle detection circuitry includes a differential calculator 11 that calculates differential values of pixel pairs in the window based on data stored in the memory elements 1, each pixel pair representing an instant angle. Then, the differential values of the pixel pairs are input to the lowest valley search circuit 12 that determines the pixel pair having the lowest differential value. The angle finding circuitry 13 then generates the angle corresponding to the pixel pair with the lowest differential value as the detected instant angle.

Also, the instant angle detection can be implemented by dividing the window into multiple regions, comparing the differential values of the representative pixel pairs to select the region likely having the highest correlation, and determining the pixel pair in the selected region with the lowest differential value and highest correlation. In an exemplary embodiment shown in FIG. 10, the instant angle detection circuitry includes a differential calculator 21 that is capable of calculating differential values of various pixel pairs based on the pixel data stored in the memory elements 1 (FIG. 3). The instant angle detection circuitry also includes a global region detector 22. The global region detector 22 compares the differential values of representative pixel pairs, each of which represents a different region within the window, calculated by the differential calculator 21. For example, the 15 by 2 window shown in FIG. 4 may be divided into three regions, the first region from the B7-N7 pixel pair (8 degrees in the clockwise direction) to the B2-N2 pair (27 degrees in the clockwise direction), the second region from the B2-N2 pixel pair to A2-P2 pair (27 degrees in the counterclockwise direction), and the third region from the A2-P2 pair to the A7-P7 pair (8 degrees in the counterclockwise direction). The global region detector 22 compares the differential values of the B2-N2 pair, U-D pair, and A2-P2 pair, and determines the pair with the lowest differential value among these three pairs.

If the B2-N2 pair has the lowest differential value, it is likely that the highest correlation will be found in the B7-N7 pair to B2-N2 pair region. If the U-D pair has the lowest differential value, the center region likely has the highest correlation. Finally, if the A2-N2 pair has the lowest differential value of the three, the A2-P2 pair to A7-P7 pair region likely has the highest correlation.

In the example shown in FIG. 4, the edge is located along the A4-P4 pixel pair. Thus, the global region detector 22 would find that the A2-P2 pair has the lowest differential value of the three representative pixel pairs, thus selecting the A7-P7 to A2-P2 region.

Once the region likely having the highest correlation is selected, the first valley detector 23 determines the pixel pair with the lowest differential value within the selected region. For example, in the example shown in FIG. 4, the differential value of the A2-P2 pair is compared with that of the A3-P3 pair. Since the differential value of the A3-P3 pair is smaller in the example, the first valley detector 23 compares the differential value of the A3-P3 pair with the differential value of the A4-P4 pair. In this example, the A4-P4 pair, where the edge lines, has a smaller differential value than the A3-P3 pair. Then, the differential value of the A4-P4 pair is compared with that of the A5-P5 pair. Since the differential value of the A4-P4 pair is smaller than that of the A5-P5 pair in this example, the search for the first valley ends with the A4-P4 pair being found as having the lowest differential value. Thus, the first valley detector 23 outputs the A4-P4 as the pixel pair having the highest correlation, and the angle finding circuitry 24 outputs the angle corresponding to the A4-P4 pair as the instant angle.

As shown in FIG. 10, the instant angle detection circuitry 2 (see FIG. 3) may also optionally include an angle reliability detector 25 and angle adjustment circuitry 26. The angle reliability detector 25 compares the differential value of the pixel pair found to have the highest correlation by the first valley detector 23 with the differential value for the pixel pair at 90°. Then, depending on the result of this comparison, the angle adjustment circuitry 26 outputs as the instant angle either the angle output by the angle finding circuitry 24 or 90°. If the angle reliability detector 25 determines that the differential value of the pixel pair (A4-P4) detected by the first valley detector 23 is considerably smaller than the differential value for the pixel pair at 90°, then the angle adjustment circuitry 26 outputs as the instant angle the angle corresponding to the pixel pair detected by the first valley detector 23 (i.e., the angle output by the angle finding circuitry 24). On the other hand, if there is no significant difference between the differential values of these two pixel pairs, then the angle adjustment circuitry outputs 90° as the instant angle.

Depending on the particular application or the display device used, the use of the substantial angle detection circuitry 3 and regional measurement circuitry 4, along with the angle confirmation circuitry 5, (see FIG. 3) may not be necessary. Thus, another exemplary embodiment of the present invention employs the particular implementations of the instant angle detection circuitry discussed above and shown in FIGS. 9 and 10 to determine the interpolation angle directly without the use of the substantial angle detection circuitry 3 or regional measurement circuitry 4. As discussed above, the low pass filter 6 may optionally be used.

Also, in another embodiment, the display image enhancement device of the present invention does not employ the instant angle detection circuitry 2, regional measurement circuitry 4, or angle confirmation circuitry 5 (see FIG. 3). Instead, in this exemplary embodiment, the image enhancement device relies on the substantial angle detection circuitry 3 (FIG. 3) to determine the interpolation angle, which is in turn used to calculate the value of the new pixel. Again, the low pass filter 6 may optionally be used.

The substantial angle detection circuitry 3 (FIG. 3) may also be implemented in different ways. FIGS. 11 and 12 show exemplary implementations of the substantial angle detection circuitry. In these exemplary implementations, the substantial angle detection circuitry includes a recursive filter 34 or 47 that filters the differential values calculated by the differential calculator 11 or 21 in the instant angle detection circuitry (FIGS. 9 and 10). Then, the filtered differential values are processed in the same manner as in the instant angle detection circuitry to determine the substantial angle.

The filtered differential value for a given angle may, for example, be calculated as follows:
F₀=WᵢₙDᵢₙ+W_{d}D_{d},
wherein F refers to a filtered differential value, W refers to a weighting constant with the combination of all weighting constants equaling 1, Dᵢₙ refers to an unfiltered differential value calculated by the differential calculator 11 or 21 in the instant angle detection circuitry, D_{d} refers to the accumulated data (i.e., a combination of previously calculated differential values corresponding to the same angle), and 0 refers to the current cycle. Exemplary sets of coefficients of the recursive filter include:
(1) Wᵢₙ=1/2 and W_{d}=½,
(2) Wᵢₙ=⅓and W_{d}=⅔,
(3) Wᵢₙ=¼and W_{d}=¾,
(4) Wᵢₙ=⅛and W_{d}=⅞, and
(5) Wᵢₙ=1/16 and W_{d}=7/16.
   Other combinations of weighting constants, the sum of which equals 1, can be used.

It will be apparent to those skilled in the art that various modifications and variations can be made in the display image enhancement apparatus and method of the present invention without departing from the spirit or scope of the invention. Thus, it is intended that the present invention cover the modifications and variations of this invention provided they come within the scope of the appended claims and their equivalents.

1. A display image enhancement apparatus for use in generating additional pixel data from input image data, wherein a window of input pixel data is used to generate data for an additional pixel to be placed substantially in the center of the window, the display image enhancement apparatus comprising:
memory elements capable of receiving a chain of input pixel data and storing at least the window of input pixel data, the window of input pixels including a plurality of pixel pairs each of which respectively represents an angle of correlation;
instant angle detection circuitry capable of receiving the input pixel data stored in the memory elements and determining an instant angle having the highest correlation based on differential values of at least some of the pixel pairs, wherein a differential value is the difference between the values of pixels in a pixel pair;
substantial angle detection circuitry capable of determining a substantial angle having the highest correlation based on filtered differential values of at least some of the pixel pairs;
angle confirmation circuitry capable of determining an interpolation angle based on the instant angle and the substantial angle; and
an interpolator capable of determining the value of the additional pixel based on the values of pixels in the pixel pair corresponding to the interpolation angle.

2. The display image enhancement apparatus according to claim 1, further comprising a regional measurement circuitry capable of determining a general image pattern within the window of pixel data stored in the memory elements,
wherein the angle confirmation circuitry is capable of determining the interpolation angle based on the instant angle, the substantial angle, and the general image pattern.

3. The display image enhancement apparatus according to claim 2, wherein if the regional measurement circuitry detects an alphabet or numerical character, the angle confirmation circuitry generates 90° as the interpolation angle.

4. The display image enhancement apparatus according to claim 1, wherein if the instant angle and substantial angle are substantially equal to each other, the angle confirmation circuitry generates as the interpolation angle one of the instant angle, the substantial angle, and the average of instant angle and substantial angle.

5. The display image enhancement apparatus according to claim 1, wherein if the instant angle is substantially different from the substantial angle, the angle confirmation circuitry generates as the interpolation angle either the substantial angle or the weighted average of the instant angle and the substantial angle with the substantial angle given more weight.

6. The display image enhancement apparatus according to claim 1, further comprising a low pass filter capable of filtering the interpolation angle and generating a filtered interpolation angle,
wherein the interpolator is capable of determining the value of the additional pixel based on the values of pixels in the pixel pair corresponding to the filtered interpolation angle.

7. The display image enhancement apparatus according to claim 1, wherein the instant angle detection circuitry includes:
a differential calculator capable of calculating differential values of at least some of the pixel pairs in the window based on the pixel data stored in the memory elements.

8. The display image enhancement apparatus according to claim 7, wherein the instant angle detection circuitry further includes:
a lowest valley search circuit capable of determining the pixel pair in the window of pixels with the lowest differential value; and
angle finding circuitry capable of determining an angle corresponding to the pixel pair with the lowest differential value and generating the determined angle as the instant angle.

9. The display image enhancement apparatus according to claim 7, wherein the window of pixels includes a plurality of regions, and the instant angle detection circuitry further includes:
a global region detector capable of selecting a representative pixel pair from each of the regions, determining the representative pixel pair having the lowest differential value among the representative pixels, and selecting the region represented by the representative pixel pair with the lowest differential value;
a first valley detector capable of comparing the differential values of consecutive sets of immediately adjacent pixel pairs within the selected region and determining a pixel pair having a differential value that is smaller than the differential values of available immediately adjacent pixel pairs to the left and to the right in the selected region;
angle finding circuitry capable of determining an angle corresponding to the pixel pair determined by the first valley detector;
an angle reliability detector capable of comparing the differential value of the pixel pair determined by the first valley detector and the differential value of the pixel pair representing a 90° correlation; and
angle adjustment circuitry capable of outputting 90° as the instant angle if the differential value of the pixel pair determined by the first valley detector is greater than or substantially the same as the differential value of the pixel pair representing the 90° correlation, and otherwise outputting the angle determined by the angle finding circuitry as the instant angle.

10. The display image enhancement apparatus according to claim 7, wherein the substantial angle detection circuitry includes:
a recursive filter capable of filtering the differential values of at least some of the pixel pairs in the window;
a lowest valley search circuit capable of determining the pixel pair in the window of pixels with the lowest filtered differential value; and
angle finding circuitry capable of determining an angle corresponding to the pixel pair with the lowest filtered differential value and generating the determined angle as the substantial angle.

11. The display image enhancement apparatus according to claim 7, wherein the window of pixels includes a plurality of regions, and the substantial angle detection circuitry includes:
a recursive filter capable of filtering the differential values of at least some of the pixel pairs in the window;
a global region detector capable of selecting a representative pixel pair from each of the regions, determining the representative pixel pair having the lowest filtered differential value among the representative pixel pairs, and selecting the region represented by the representative pixel pair with the lowest filtered differential value;
a first valley detector capable of comparing the filtered differential values of consecutive sets of immediately adjacent pixel pairs within the selected region and determining a pixel pair first found to have a filtered differential value that is smaller than the filtered differential values of available immediately adjacent pixel pairs to the left and to the right in the selected region;
angle finding circuitry capable of determining an angle corresponding to the pixel pair determined by the first valley detector;
an angle reliability detector capable of comparing the filtered differential value of the pixel pair determined by the first valley detector and the filtered differential value of the pixel pair representing a 90° correlation; and
angle adjustment circuitry capable of outputting 90° as the substantial angle if the filtered differential value of the pixel pair determined by the first valley detector is greater than or substantially the same as the filtered differential value of the pixel pair representing the 90° correlation, and otherwise outputting the angle determined by the angle finding circuitry as the substantial angle.

12. An display image enhancement apparatus for use in generating additional pixel data from input image data, wherein a window of input pixel data includes a plurality of regions and is used to generate data for an additional pixel to be placed substantially in the center of the window, the display image enhancement apparatus comprising:
memory elements capable of receiving a chain of input pixel data and storing at least the window of input pixel data, the window of input pixels including a plurality of pixel pairs each of which respectively represents an angle of correlation;
instant angle detection circuitry capable of receiving the pixel data stored in the memory elements and determining an instant angle having the highest correlation based on differential values of at least some of the pixel pairs, wherein a differential value is the difference between the values of pixels in a pixel pair and wherein the instant angle detection circuitry includes
a differential calculator capable of calculating differential values of at least some of the pixel pairs in the window,
a global region detector capable of selecting a representative pixel pair from each of the regions, determining the representative pixel pair having the lowest differential value among the representative pixel pairs, and selecting the region represented by the representative pixel pair with the lowest differential value,
a first valley detector capable of comparing the differential values of consecutive sets of immediately adjacent pixel pairs within the selected region and determining a pixel pair having a differential value that is smaller than the differential values of available immediately adjacent pixel pairs to the left and to the right in the selected region, and
angle finding circuitry capable of determining an angle corresponding to the pixel pair determined by the first valley detector as the instant angle; and
an interpolator capable of determining the value of the additional pixel based on the values of pixels in the pixel pair corresponding to the instant angle.

13. The display image enhancement apparatus of claim 12, wherein the instant angle detection circuitry further includes:
an angle reliability detector capable of comparing the differential value of the pixel pair determined by the first valley detector and the differential value of the pixel pair representing a 90° correlation; and
angle adjustment circuitry capable of outputting 90° as the instant angle if the differential value of the pixel pair determined by the first valley detector is greater than or substantially the same as the differential value of the pixel pair representing the 90° correlation, and otherwise outputting the angle determined by the angle finding circuitry as the instant angle.

14. An display image enhancement apparatus for use in generating additional pixel data from input image data, wherein a window of input pixel data is used to generate data for an additional pixel to be placed substantially in the center of the window, the display image enhancement apparatus comprising:
memory elements capable of receiving a chain of input pixel data and storing at least the window of input pixel data, the window of input pixels including a plurality of pixel pairs each of which respectively represents an angle of correlation;
a differential calculator capable of calculating a differential value of at least some of the pixel pairs in the window based on the input pixel data, wherein a differential value is the difference between the values of pixels in a pixel pair;
substantial angle detection circuitry capable of determining a substantial angle having the highest correlation based on filtered differential values of at least some of the pixel pairs, wherein the substantial angle detection circuitry includes a recursive filter capable of filtering the differential values of at least some of the pixel pairs in the window and outputting the filtered differential values; and
an interpolator capable of determining the value of the additional pixel based on the values of pixels in the pixel pair corresponding to the substantial angle.

15. The display image enhancement apparatus of claim 14, wherein the window includes a plurality of regions and the substantial angle detection circuitry further includes:
a global region detector capable of selecting a representative pixel pair from each of the regions, determining the representative pixel pair having the lowest filtered differential value among the representative pixel pairs, and selecting the region represented by the representative pixel pair with the lowest filtered differential value;
a first valley detector capable of comparing the filtered differential values of consecutive sets of immediately adjacent pixel pairs within the selected region and determining a pixel pair having a filtered differential value that is smaller than the filtered differential values of available immediately adjacent pixel pairs to the left and to the right in the selected region; and
angle finding circuitry capable of determining an angle corresponding to the pixel pair determined by the first valley detector and outputting the determined angle as the substantial angle.

16. The display image enhancement apparatus of claim 15, wherein the substantial angle detection circuitry further includes:
an angle reliability detector capable of comparing the filtered differential value of the pixel pair determined by the first valley detector and the filtered differential value of the pixel pair representing a 90° correlation; and
angle adjustment circuitry capable of outputting 90° as the substantial angle if the filtered differential value of the pixel pair determined by the first valley detector is greater than or substantially the same as the filtered differential value of the pixel pair representing the 90° correlation, and otherwise outputting the angle determined by the angle finding circuitry as the substantial angle.

17. A display image enhancement method for use in generating additional pixel data from input image data, wherein a window of input pixel data is used to generate data for an additional pixel to be placed substantially in the center of the window, the display image enhancement method comprising the steps of:
receiving a chain of input pixel data and storing at least the window of input pixel data in memory elements, the window of input pixels including a plurality of pixel pairs each of which respectively represents an angle of correlation;
determining differential values of at least some of the pixel pairs based on the input pixel data stored in the memory elements, wherein a differential value is the difference between the values of pixels in a pixel pair;
determining an instant angle having the highest correlation based on the differential values of at least some of the pixel pairs;
determining a substantial angle having the highest correlation based on filtered differential values of at least some of the pixel pairs;
determining an interpolation angle based on the instant angle and the substantial angle; and
determining the value of the additional pixel based on the values of pixels in the pixel pair corresponding to the interpolation angle.

18. The display image enhancement method according to claim 17, further comprising the step of determining a general image pattern within the window of pixel data stored in the memory elements,
wherein the interpolation angle is determined based on the instant angle, the substantial angle, and the general image pattern.

19. The display image enhancement method according to claim 18, wherein if the determined general pattern is an alphabet or numerical character, 90° is determined as the interpolation angle.

20. The display image enhancement method according to claim 17, wherein if the instant angle and substantial angle are substantially equal to each other, one of the instant angle, the substantial angle, and the average of instant angle and substantial angle is determined as the interpolation angle.

21. The display image enhancement method according to claim 17, wherein if the instant angle is substantially different from the substantial angle, either the substantial angle or the weighted average of the instant angle and the substantial angle with the substantial angle given more weight is determined as the interpolation angle.

22. The display image enhancement apparatus according to claim 17, further comprising the steps of filtering the interpolation angle with a low pass filter and generating a filtered interpolation angle,
wherein the value of the additional pixel is determined based on the values of pixels in the pixel pair corresponding to the filtered interpolation angle.

23. The display image enhancement method according to claim 17, wherein the step of determining the instant angle includes the steps of:
determining the pixel pair in the window of pixels with the lowest differential value; and
determining an angle corresponding to the pixel pair with the lowest differential value and generating the determined angle as the instant angle.

24. The display image enhancement method according to claim 17, wherein the window of pixels includes a plurality of regions, and the step of determining the instant angle includes the steps of:
selecting a representative pixel pair from each of the regions;
determining the representative pixel pair having the lowest differential value among the representative pixels;
selecting the region represented by the representative pixel pair with the lowest differential value;
comparing the differential values of consecutive sets of immediately adjacent pixel pairs within the selected region and determining a first valley pixel pair, wherein the first valley pixel pair has a differential value that is smaller than the differential values of available immediately adjacent pixel pairs to the left and to the right in the selected region;
determining an angle corresponding to the first valley pixel pair;
comparing the differential value of the first valley pixel pair and the differential value of the pixel pair representing a 90° correlation; and
outputting 90° as the instant angle if the differential value of the first valley pixel pair is greater than or substantially the same as the differential value of the pixel pair representing the 90° correlation, and otherwise outputting the angle corresponding to the first valley pixel pair as the instant angle.

25. The display image enhancement method according to claim 17, wherein the step of determining the substantial angle includes the steps of:
filtering the differential values of at least some of the pixel pairs in the window using a recursive filter;
determining the pixel pair in the window of pixels with the lowest filtered differential value; and
determining an angle corresponding to the pixel pair with the lowest filtered differential value and generating the determined angle as the substantial angle.

26. The display image enhancement method according to claim 17, wherein the window of pixels includes a plurality of regions, and the step of determining the substantial angle includes the steps of:
filtering the differential values of at least some of the pixel pairs in the window using the recursive filter;
selecting a representative pixel pair from each of the regions;
determining the representative pixel pair having the lowest filtered differential value among the representative pixel pairs;
selecting the region represented by the representative pixel pair with the lowest filtered differential value;
comparing the filtered differential values of consecutive sets of immediately adjacent pixel pairs within the selected region and determining a first valley pixel pair, wherein the first valley pixel pair has a filtered differential value that is smaller than the filtered differential values of available immediately adjacent pixel pairs to the left and to the right in the selected region;
determining an angle corresponding to the first valley pixel pair;
comparing the filtered differential value of the first valley pixel pair and the filtered differential value of the pixel pair representing a 90° correlation; and
outputting 90° as the substantial angle if the filtered differential value of the first valley pixel pair is greater than or substantially the same as the filtered differential value of the pixel pair representing the 90° correlation, and otherwise outputting the angle corresponding to the first valley pixel pair as the substantial angle.

27. An display image enhancement method for use in generating additional pixel data from input image data, wherein a window of the pixel data includes a plurality of regions and is used to generate data for an additional pixel to be placed substantially in the center of the window, the display image enhancement method comprising the steps of:
receiving a chain of input pixel data and storing at least the window of input pixel data in memory elements, the window of input pixels including a plurality of pixel pairs each of which respectively represents an angle of correlation;
determining differential values of at least some of the pixel pairs in the window, wherein a differential value is the difference between the values of pixels in a pixel pair;
determining an instant angle having the highest correlation based on differential values of at least some of the pixel pairs, wherein the step of determining the instant angle includes
selecting a representative pixel pair from each of the regions,
determining the representative pixel pair having the lowest differential value among the representative pixel pairs,
selecting the region represented by the representative pixel pair with the lowest differential value,
comparing the differential values of consecutive sets of immediately adjacent pixel pairs within the selected region and determining a first valley pixel pair, wherein the first valley pixel pair has a differential value that is smaller than the differential values of available immediately adjacent pixel pairs to the left and to the right in the selected region, and
determining an angle corresponding to the first valley pixel pair as the instant angle; and
determining the value of the additional pixel based on the values of pixels in the pixel pair corresponding to the instant angle.

28. The display image enhancement method of claim 27, wherein the step of determininig the instant angle further includes the steps of:
comparing the differential value of the first valley pixel pair and the differential value of the pixel pair representing a 90° correlation; and
outputting 90° as the instant angle if the differential value of the first valley pixel pair is greater than or substantially the same as the differential value of the pixel pair representing the 90° correlation, and otherwise outputting the angle corresponding to the first valley pixel pair as the instant angle.

29. An display image enhancement method for use in generating additional pixel data from input image data, wherein a window of the pixel data is used to generate data for an additional pixel to be placed substantially in the center of the window, the display image enhancement method comprising the steps of:
receiving a chain of input pixel data and storing at least the window of input pixel data in memory elements, the window of input pixels including a plurality of pixel pairs each of which respectively represents an angle of correlation;
calculating a differential value of at least some of the pixel pairs in the window based on the input pixel data stored in the memory elements, wherein a differential value is the difference between the values of pixels in a pixel pair;
determining a substantial angle having the highest correlation based on filtered differential values of at least some of the pixel pairs, wherein the step of determining the substantial angle includes filtering the differential values of at least some of the pixel pairs in the window using a recursive filter; and
determining the value of the additional pixel based on the values of pixels in the pixel pair corresponding to the substantial angle.

30. The display image enhancement method of claim 29, wherein the window includes a plurality of regions and the step of determining the substantial angle further includes the steps of:
selecting a representative pixel pair from each of the regions;
determining the representative pixel pair having the lowest filtered differential value among the representative pixel pairs;
selecting the region represented by the representative pixel pair with the lowest filtered differential value;
comparing the filtered differential values of consecutive sets of immediately adjacent pixel pairs within the selected region and determining a first valley pixel pair, wherein the first valley pixel pair has a filtered differential value that is smaller than the filtered differential values of available immediately adjacent pixel pairs to the left and to the right in the selected region; and
determining an angle corresponding to the first valley pixel pair as the substantial angle.

31. The display image enhancement method of claim 30, wherein the step of determining the substantial angle further includes the steps of:
comparing the filtered differential value of the first valley pixel pair and the filtered differential value of the pixel pair representing a 90° correlation; and
outputting 90° as the substantial angle if the filtered differential value of the first valley pixel pair is greater than or substantially the same as the filtered differential value of the pixel pair representing the 90° correlation, and otherwise outputting the angle corresponding to the first valley pixel pair as the substantial angle.
